(19) United States
(12) Patent Application Publication
(10) Pub. No.: US 2018/0088663 A1
(43) Pub. Date: Mar. 29, 2018

(54) METHOD AND SYSTEM FOR GESTURE-BASED INTERACTIONS

(71) Applicant: Alibaba Group Holding Limited, George Town (KY)

(72) Inventors: Lei Zhang, Beijing (CN); Wuping Du, Hangzhou (CN)

(21) Appl. No.: 15/695,980

(22) Filed: Sep. 5, 2017

(30) Foreign Application Priority Data
Sep. 29, 2016 (CN) 201610866360.9

(51) Int. Cl. G06F 3/01; G06K 9/00; G06T 7/20; G06T 19/00; G06F 3/0488

(52) U.S. Cl. CPC G06F 3/011; G06F 3/017; G06K 9/00355; G06F 3/14; G06T 7/20; G06T 19/006; G06F 3/04883; G06K 9/00389

(57) ABSTRACT

Gesture based interaction is presented, including determining, based on an application scenario, a virtual object associated with a gesture under the application scenario, the gesture being performed by a user and detected by a virtual reality (VR) system, outputting the virtual object to be displayed, and in response to the gesture, subjecting the virtual object to an operation associated with the gesture.

### CROSS REFERENCE TO OTHER APPLICATIONS

This application claims priority to People's Republic of China Patent Application No. 201610866360.9 entitled A GESTURE-BASED INTERACTION METHOD AND MEANS, filed Sep. 29, 2016 which is incorporated herein by reference for all purposes.

### FIELD OF THE INVENTION

The present application relates to a method and a system for gesture-based interactions.

### BACKGROUND OF THE INVENTION

Virtual reality (VR) technology relates to computer simulation technology that allows the creation and experience of virtual worlds. VR technology generates a simulated environment based on computers. VR technology is an interactive, three-dimensional, dynamic, visual, and physical action system simulation that melds multiple information sources, causing users to become immersed in the environment. VR technology is simulation technology combined with computer graphics human-machine interface technology, multimedia technology, sensing technology, network technology, and other technologies. VR technology can, based on head rotations and eye, hand, or other body movements, process data adapted to movements of participants and produce real-time responses to user inputs using computers.

Augmented reality (AR) technology applies virtual information to the real world based on computer technology. AR technology superimposes an actual environment and virtual objects onto the same tableau or space so that the actual environment and the virtual objects exist simultaneously.

Mixed reality (MR) technology includes augmented reality and augmented virtuality (AV). AV refers to the merging of real world objects into virtual worlds. MR technology refers to a new visualized environment generated by combining reality with a virtual world. In the new visualized environment, physical and virtual objects (i.e., digital objects) co-exist and interact in real time.

In VR, AR, or MR technology, one application can have many application scenarios, and the same user gesture in the different application scenarios can require different virtual objects for operation. Currently, there is no ready solution for how gesture-based interaction is achieved for these multi-scenario applications. There is a need for a solution to let the user control the VR, AR, or MR technology with different gestures, different fingers, or different finger joints associated with different virtual objects.

### BRIEF DESCRIPTION OF THE DRAWINGS

Various embodiments of the invention are disclosed in the following detailed description and the accompanying drawings.

FIG. 1 is a functional structural block diagram of an embodiment of system for gesture-based interactions.

FIG. 2 is a flowchart of an embodiment of a process for gesture-based interactions.

FIG. 3 is a relational diagram of an embodiment of associations between fingers and corresponding positions on a virtual object.

FIG. 4 is a flowchart of another embodiment of a process for gesture-based interactions.

FIG. 5 is a flowchart of another embodiment of a process for gesture-based interactions.

FIG. 6 is a functional diagram illustrating a programmed computer system for gesture-based interactions.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

An embodiment of the present application includes a process for gesture-based interactions. The process can be applied in VR, AR or MR applications with multiple application scenarios or can be suitable for similar applications having multiple application scenarios. An application scenario can relate to a certain mode in which an application operates.

In some embodiments, a multi-scenario application has multiple application scenarios, and switching between the multiple application scenarios is possible. For example, a sports-related VR application has many sports scenarios: a table tennis singles match scenario, a badminton singles match scenario, etc. The user can select from the various sports scenarios. In another example, a simulated combat VR application contains many combat scenarios: a pistol-shooting scenario, a close-quarters combat scenario, etc. The simulated combat VR application can switch between different combat scenarios based on user choice and application settings. In some embodiments, an application can invoke another application. Thus, switching between multiple applications can occur. In such circumstances, one application can correspond to one application scenario.

Application scenarios can be predefined, or the application scenarios can be set by a server. For example, in the case of a multi-scenario application, scenario partitioning can be predefined in a configuration file of the application or in the application's coding or the scenario partitioning can be set by the server. Terminals can store information relating to scenarios partitioned by the server in the configuration file of the application. A terminal can relate to a personal computer (PC), a mobile phone, a tablet, an embedded device, etc. In another example, partitions of application scenarios are predefined in the configuration file of the application or in the application's coding. Subsequently, the server can repartition the application scenarios and send the information relating to the repartitioned application scenarios to the terminal to increase the flexibility of multi-scenario applications.

To address different application scenarios, a gesture associated with a virtual object can be set for a corresponding application scenario. A gesture relates to a movement of part of the body. Under the application scenario, when the gesture is detected, the virtual object is invoked. The virtual object can also be called a digital object. The virtual object can be generated using computer technology and can be displayed by a terminal.

Using an example of the above sports-related VR application: in the table tennis singles match scenario, a user gesture is associated with a paddle in a hand of a participant in this scenario. In a badminton singles match scenario, a user gesture is associated with a racket in a hand of a participant in this scenario. In yet another example, relating to a simulated combat virtual reality application: in the case of a pistol-shooting scenario, a user gesture is associated with a pistol. In yet another example, relating to a close-quarters combat scenario, a user gesture is associated with a knife.

A relationship of a gesture under a corresponding application scenario to a virtual object can be predefined. For example, in the case of a multi-scenario application, a mapping relationship between the gesture and the virtual object under the application scenario can be predefined in a configuration file of the application or in the application's coding. Mapping relationships can include, for example, a movement of the first finger to control a limb of a puppet, a status of the palm to control a movement of a knife, etc. In another example, the mapping relationship can be set by the server. Terminals can store mapping relationships set by the server in the configuration file of the application. In another example, the mapping relationship is predefined in the configuration file of the application or in the application's coding. Subsequently, the server can, if required, reset the mapping relationship between the gesture and the virtual object under the application scenario and send the reset mapping relationship to the terminal, thus increasing the flexibility of the multi-scenario application.

An example of the mapping relationship between the gesture and the virtual object under the application scenario is described below:

Relating to a simulated fruit-cutting VR application, a user gesture is associated with a “paring knife.” The “paring knife” corresponds to a virtual object in the simulated fruit-cutting VR application. When running this VR application, the terminal can display a “paring knife” in a VR application interface based on a captured and recognized user gesture such as, for example, a back-and-force slicing motion by a palm. Moreover, the “paring knife” can move in tandem with the user gesture to generate a visual effect of cutting fruit within the VR application interface.

Relating to a simulated puppet-controlling VR application, a user gesture associated with a “puppet” can be controlled via a movement of multiple fingers, an arm's up or down motion, or a combination thereof. The “puppet” is a virtual object within the simulated puppet-controlling VR application. When running the VR application, the terminal can control the movements (e.g., movements in different directions) of the “puppet” displayed in the interface of the VR application based on the captured and recognized user gesture.

Furthermore, for more flexible and precise control of the “puppet,” all or some of the fingers on a user's hand can be related to corresponding positions on the “puppet.” In other words, the terminal can control the movements of the corresponding positions of the “puppet” displayed in an interface of the VR application based on a movement or status of the fingers in the captured and recognized user gesture. For example, all or some of the fingers could control the movements of the four limbs of the “puppet” and thus achieve a finer control of the virtual object.

Furthermore, all or some of the fingers of the user's hand can be related to the corresponding positions on the “puppet.” In this way, the terminal can control the movements of the corresponding positions of the “puppet” displayed in the interface of the VR application based on the movement or status of fingers in the captured and recognized user gesture. As an example, a movement of a first finger controls the head of the “puppet.” In another example, the movement or status of fingers in the captured and recognized user gesture could control the movements of the four limbs of the “puppet” and thus achieve finer control of the virtual object. Movement of the second and third fingers can control the arms of the “puppet.”

Furthermore, finger joints of the user's hand can be related to corresponding positions on the “puppet.” In this way, the terminal can control the movements of the corresponding positions of the “puppet” displayed in the interface of the VR application based on the movement or status of finger joints in the captured and recognized user gesture and thus achieve finer control of the virtual object. A first finger joint can control the head of the “puppet,” a second finger joint can control the body of the “puppet,” and a third finger joint can control the legs of the “puppet.”

The fingers and finger joints can also be combined with each other and related to corresponding positions on the “puppet.” For example, some positions on the “puppet” could relate to fingers, and other positions on the “puppet” could relate to joints.

In a pistol-shooting scenario of a simulated combat VR application, the user's hand can be associated with a “gun,” and in a close-quarters combat scenario, the user's hand can be associated with a “knife.” Both the “gun” and “knife” are virtual objects in the simulated combat VR application. Thus, in different application scenarios, the associated virtual objects can be displayed based on user gestures. In addition, various statuses and movements of the virtual objects can be controlled by the user gestures.

Furthermore, the finger joints of the user's hand can be related to corresponding positions on the “gun.” As an example, the terminal can control operation of the gun based on the movement or status of finger joints in the captured and recognized user gesture, e.g., pulling the trigger. Accordingly, finer control of the virtual object can be achieved.

In the case of some video playback applications or social networking applications, a user gesture can be associated with a virtual input device (such as, for example, a virtual keyboard or a virtual mouse). For example, the positions of finger joints of the user's hand are associated with corresponding positions on the virtual input device. For example, the finger joints of the user's hand are associated with the left or right key of a virtual mouse or with various keys of a virtual keyboard. In this way, the virtual input device can be operated based on the user gesture and provide responses based on operations of the virtual device.

As an example, using a right hand as an example, a position (up or down) of the user's thumb can be associated with the letter A on a virtual keyboard, a position of the user's first joint (joint near the tip of the finger) of a first finger (next to the thumb) can be associated with the letter B, a position of the user's second joint of the first finger can be associated with the letter F, a position of the user's first joint of a second finger (next to the first finger) can be associated with the letter C, a position of the user's second joint of the second finger can be associated with the letter G, a position of the user's first joint of a third finger (next to the second finger) can be associated with the letter D, a position of the user's second joint of the third finger can be associated with the letter H, and a position of the user's first joint of a fourth finger (next to the fourth finger) can be associated with the letter E, a position of the user's second joint of the fourth finger can be associated with the letter I. So, the user can type any letter A-I by making gestures using the various fingers and thumb. The letters can be remapped to different positions on the various joints of the user's right hand, or the user's left hand can be used. There is no limitation on the mapping of the letters and the various joints.

For other application scenarios, the user gesture can be associated with multiple virtual objects. For example, different fingers are associated with corresponding virtual objects, or different finger joints are associated with different virtual objects. For example, the touching of the first and second fingers together relates to the control of the opening of the mouth of the “puppet.” In another example, one finger could control a little “puppet” where a first finger joint controls the head of the “puppet,” a second finger joint controls the body of the “puppet,” and a third finger joint controls the legs of the “puppet.”

In some embodiments, a terminal that runs a multi-scenario application is an electronic device capable of running the multi-scenario application. The terminal can include a component used to capture gestures, a component for determining, based on an application scenario, the virtual objects associated with the gestures under that application scenario and performing operations on the associated virtual object based on the gestures, a component for display, etc. In the example of terminals running virtual reality applications, the gesture capturing components can include infrared cameras or other kinds of sensors (such as optical sensors or accelerometers), and display components can display virtual reality scenario images, provide response operation results based on gestures, etc. In some embodiments, the gesture capturing components, the display components, etc. do not need to be integrated with the terminal, but can instead be external components connected to the terminal.

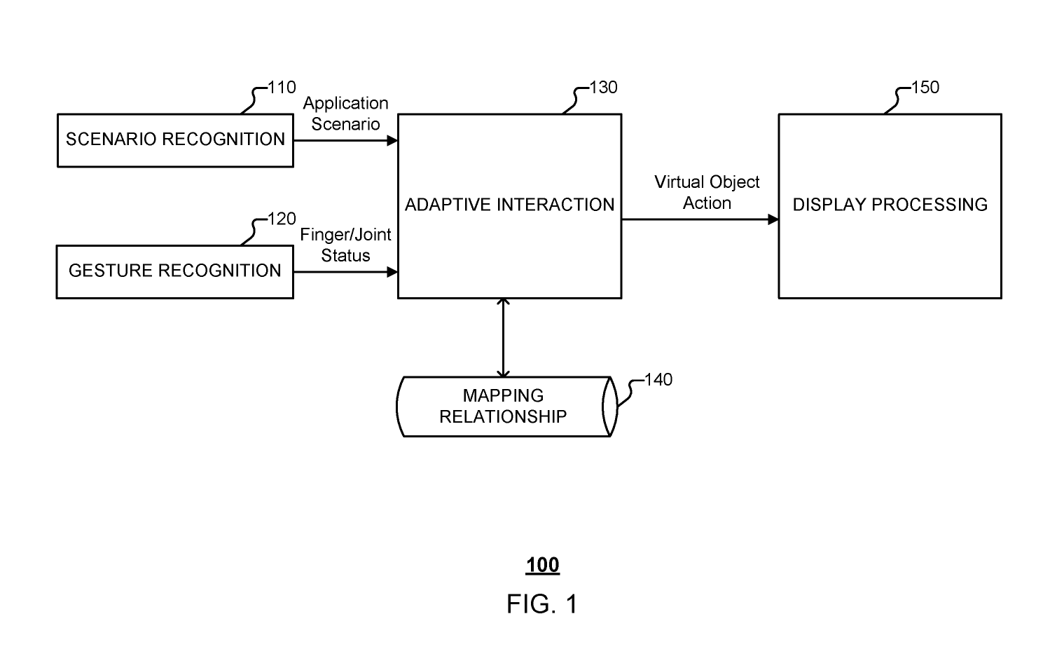

FIG. 1 is a functional structural block diagram of an embodiment of system for gesture-based interactions. In some embodiments, the system 100 includes a scenario recognition module 110, a gesture recognition module 120, an adaptive interaction module 130, a mapping relationship module 140, and a display processing module 150.

In some embodiments, the scenario recognition module 110 is configured to recognize application scenarios. Various application scenarios can be recognized by conventional scene recognition technology.

In some embodiments, the gesture recognition module 120 is configured to recognize user gestures. Various user gestures can be recognized by conventional gesture recognition technology. The user gesture recognition results can include finger statuses and movements, finger joint statuses and movements, hand position statuses, and/or other appropriate gesture statuses and movements.

In some embodiments, the adaptive interaction module 130 is configured to, based on a recognized application scenario, query the mapping relationship module 140. Mapping relationship module 140 is configured to determine a mapping relationship between a virtual object associated with the user gesture under the application scenario, and, based on the gesture recognition result, perform an operation on the virtual object.

In some embodiments, the display processing module 150 is configured to provide displays based on adaptive interaction results. For example, the display processing module 150 processes for display different movements or statuses of a virtual object under gesture control.

The above system 100 can be implemented by a computer program or by a computer program in combination with hardware. For example, the system 100 can be implemented by a gestured-based interactive means such as a virtual reality headset.

The modules described above can be implemented as software components executing on one or more general purpose processors, as hardware such as programmable logic devices and/or Application Specific Integrated Circuits designed to perform certain functions, or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices. The functions of the modules may be merged into one another or further split into multiple sub-modules.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

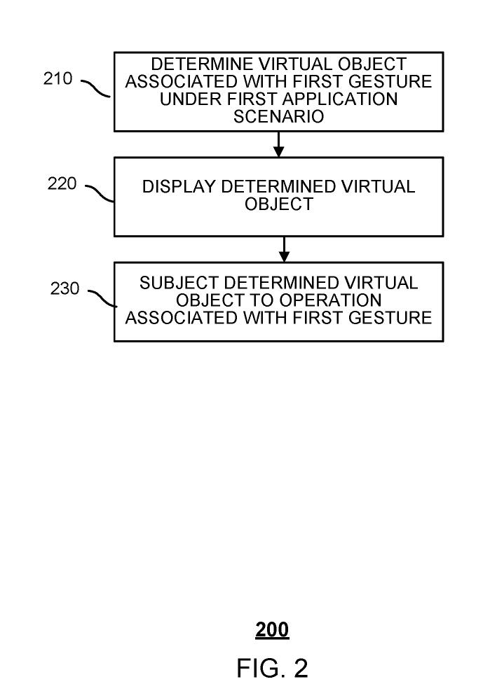

Based on the functional structural block diagram described above, FIG. 2 presents the example of a gesture-based interaction process provided by an embodiment of the present application.

FIG. 2 is a flowchart of an embodiment of a process for gesture-based interactions. In some embodiments, the process 200 is implemented by an operating system running on the system 100 of FIG. 1 and comprises:

In 210, a virtual object associated with a first gesture under a first application scenario is determined based on the first application scenario.

The “first application scenario” is used merely for purposes of discussion and does not refer to a type or category of application scenario.

In a particular implementation involving the first application scenario, the system can acquire a mapping relationship between a gesture and a virtual object under the application scenario, and determine, based on the mapping relationship, the virtual object associated with the gesture under the first application scenario. As discussed above, the mapping relationship can be predefined, or the mapping relationship can be set by a server and sent to the system in response to a request.

In some embodiments, in the determining of the virtual object operation, the gesture recognition occurs first, and then, the system, based on the first application scenario where the gesture recognition occurred, determines the virtual object associated with the gesture under the first application scenario.

In some embodiments, the system supports multiple modes of capturing user gestures. For example, an infrared camera is used to capture images, and the system obtains the user gesture by performing gesture recognition on the captured images. If this approach is used to capture gestures, then the system can capture barehanded gestures or palm gestures. For example, the barehanded gesture can relate to the making of a fist to pull a trigger.

In some embodiments, to increase the precision of the gesture recognition operation, the images captured by the infrared camera are preprocessed to eliminate noise. For example, the image preprocessing operations can include:

Image enhancement. Brightness enhancement is to be performed in the event external lighting is insufficient or too intense. Brightness enhancement can increase the accuracy of the gesture detection and the recognition precision. For example, in some embodiments, brightness parameter detection is performed as follow: calculate a mean brightness (Y) value of the video frame, and use a threshold value T. If Y>T, the results indicate that brightness is too high. Otherwise, the brightness indicates relative dimness. Furthermore, a non-linear algorithm can be used to calculate Y enhancement, such as Y′=Y*a+b. Values for parameters a and b can be derived from experience.

Image binarization. Image binarization refers to setting grayscale values of pixel points on an image to 0 or 255. In other words, image binarization relates to causing the image as a whole to exhibit an obvious black-and-white effect.

Grayscale image conversion. In an RGB (Red-Green-Blue) model, if R=G=B, then color is expressed as a grayscale color where the value of R=G=B is called a grayscale value. Therefore, each pixel of a grayscale image can correspond to only one byte that stores a grayscale value (also called intensity value or brightness value). The range of the grayscale values is from 0 to 255.

Noise elimination. Noise elimination relates to the elimination of noise points from an image. This noise elimination can be performed by applying a bandpass filter to the image.

During a particular implementation, the system can determine whether to perform image preprocessing or determine the image processing technique that is to be used based on gesture precision requirements and performance requirements (such as, for example, response speed).

During gesture recognition, the gesture can be recognized based on a gesture classification model. When a gesture is recognized based on the gesture classification model, input parameters for the gesture classification model can be images captured by an infrared camera (or preprocessed images), and output parameters can be gesture types. The gesture classification model can be obtained using a learning approach based on a support vector machine (SVM), a convolutional neural network (CNN), a deep learning (DL) algorithm, or other such algorithm.

In some embodiments, to achieve a more precise control over a virtual object, the system recognizes the statuses of the user's finger joints during gesture recognition. In some embodiments, different finger joints correspond to different positions on the virtual object. Thus, when performing operations on the virtual object based on a gesture under a first application scenario, the system can perform operations on corresponding positions on the virtual object based on the statuses of different finger joints in the gesture under the first application scenario. A specific technique for joint recognition can relate to a Kinect algorithm. Hand modeling can be used to obtain joint information with which joint recognition is performed.

In 220, the determined virtual object is output for display. The system can perform processing to output the virtual object for display.

In the event that the virtual object is being displayed, the system can output for display the virtual object based on a current status of the first gesture. For example, the system can be configured to determine at least one of the following:

The system can determine display attributes of the virtual object based on the current status of the first gesture and provide the corresponding display. The display attributes of the virtual object can include color, transparency, gradient effect, or any combination thereof.

The system can determine a form of the virtual object based on the current status of the first gesture and provide the corresponding display. In this respect, the status of the virtual object can include virtual object length, width, and height, virtual object shape, or a combination thereof. The form can include a knife, a gun, a sword, etc.

The system can determine an attitude of the virtual object based on the current status of the first gesture and provide the corresponding display. The attitude of the virtual object can include: elevation angle, angle of rotation, angle of deflection, or any combination thereof.

The system can determine a spatial position of the virtual object based on the current status of the first gesture and provide the corresponding display. The spatial position of the virtual object can include the depth of field of the virtual object in the current application scenario picture.

For VR, the system can display the determined virtual object within the currently simulated first application scenario. For AR, the system can display the determined virtual object within the first application scenario where the first application scenario includes the current simulation superimposed on the actual scene. For MR, the system can display the determined virtual object within the first application scenario where the first application scenario includes the current simulation fused with (or combined with) the actual scene.

In 230, in response to a received first gesture operation, the system subjects the determined virtual object to an operation associated with the first gesture operation.

In some embodiments, the system, based on the following motion information in the first gesture operation, performs an operation on the virtual object. The motion information in the first gesture operation can include motion track, motion speed, motion magnitude, rotation angle, hand status, or any combination thereof.

In some embodiments, the hand status includes a status of the entire palm (e.g., palm up or palm down), finger status, finger joint status, or any combination thereof. In some embodiments, the status includes attitude, whether a finger is bent, in which direction a finger is bent, and/or any other appropriate information regarding the state of the user's hand. The attitude of the hand can include elevation angle, angle of rotation, angle of deflection, or any combination thereof.

Using the example of the process 200 shown in FIG. 2 as applied to the VR application of the simulated fruit cutting described above, the gesture-based interactive process can include:

In 210, the VR application is running and enters the fruit-cutting scenario. The scenario recognition function of [the application? the operating system?] recognizes the type of scenario. An adaptive interaction function, based on the recognized application scenario, queries a mapping relationship of a gesture under the application scenario to a virtual object to obtain that the virtual object associated with the gesture under the application scenario is a “paring knife.”

In 220, the system displays a paring knife in the current virtual reality scenario.

In 230, under the current virtual reality scenario, the user waves their hand to make a gesture of cutting fruit. The gesture recognition function recognizes the user gesture to obtain gesture-related parameters. The gesture-related parameters can include a status of an entire palm (such as the orientation of the palm center), motion speed, motion magnitude, motion track, angle of rotation, or any combination thereof. The adaptive interaction function, based on the recognized gesture, performs an operation with the “paring knife,” which is the virtual object associated with the gesture, enabling the “paring knife” to move based on the motion of the gesture. The movement of the “paring knife” achieves the effect of cutting fruit. For example, the orientation of the paring knife blade edge can be determined based on the orientation of the palm center, the motion track of the paring knife can be determined based on the motion track, the fruit-cutting force of the paring knife can be determined based on the motion speed and motion magnitude, etc.

In another example of process 200 applied to the VR application of the simulated puppet control, the gesture-based interactive process includes:

In 210, the VR application is running and enters the puppet control scenario. The scenario recognition function recognizes the type of scenario. In this example, the adaptive interaction function, based on the recognized application scenario, queries the mapping relationship of the gesture under the application scenario to the virtual object in order to obtain the fact that the virtual object associated with the gesture under the application scenario is a “puppet.”

In 220, the system displays the “puppet” in the current virtual reality scenario. For example, a “puppet” is rendered in a head-mounted display, a monitor, or the like.

In 230, under the application scenario, the user moves each finger to make a gesture of controlling the puppet. The gesture recognition function recognizes the user gesture to obtain gesture-related parameters. The gesture-related parameters can include parameters relating to the entire hand and each finger and finger joint. These gesture-related parameters can include motion speed, motion magnitude, motion track, angle of rotation, or any combination thereof. The adaptive interaction function, based on the recognized gesture, can perform an operation on the “puppet,” which is the virtual object associated with the gesture, enabling different positions on the “puppet” to move based on the motion of each finger of the gesture and to achieve the effect of puppet motion.

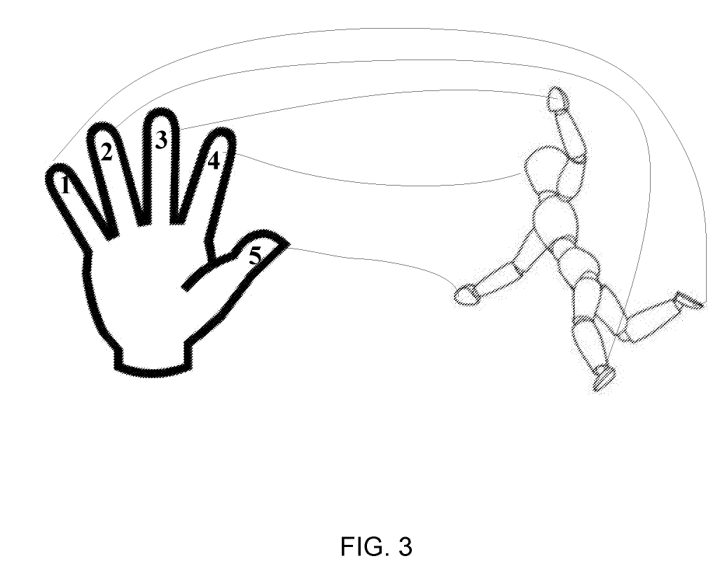

FIG. 3 is a relational diagram of an embodiment of associations between fingers and corresponding positions on a virtual object. For example, the virtual object is a puppet. Finger 1, finger 2, finger 3, and finger 5 are individually associated with the four limbs of the “puppet,” and finger 4 is associated with the head of the “puppet.” The status or movement of different fingers can cause a change in the movement or status of the corresponding position on the “puppet.”

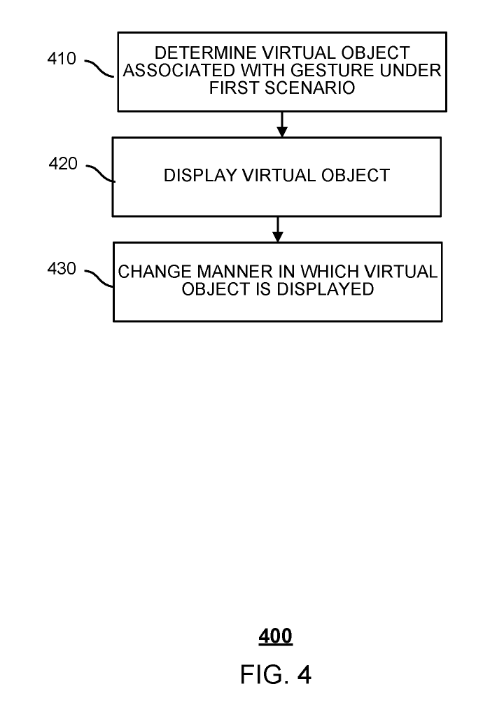

FIG. 4 is a flowchart of another embodiment of a process for gesture-based interactions. In some embodiments, the process 400 is implemented by the system 100 of FIG. 1 and comprises:

In 410, the system determines, based on a first scenario, a virtual object associated with a gesture under the first scenario.

In operation 410, the system can first acquire a mapping relationship between a gesture and a virtual object under the application scenario, and then determine, based on the mapping relationship, the virtual object associated with the first gesture under the first application scenario. The mapping relationship can be predefined or set by a server. Furthermore, the gesture recognition can be performed before operation 410.

In 420, the system displays the virtual object.

In operation 420, the system can display the virtual object based on the current status of the first gesture. The system can perform at least one of the following:

The system can determine display attributes of the virtual object based on the current status of the first gesture and provide the corresponding display. The display attributes of the virtual object can include the following attributes: color, transparency, gradient effect, etc., or any combination thereof.

The system can determine a form of the virtual object based on the current status of the first gesture and provide the corresponding display. In this respect, the form of the virtual object can include: virtual object length, width, and height, virtual object shape, etc., or any combination thereof.

The system can determine an attitude of the virtual object based on the current status of the first gesture and provide the corresponding display. The attitude of the virtual object can include elevation angle, angle of rotation, angle of deflection, etc., or any combination thereof.

The system can determine a spatial position of the virtual object based on the current status of the first gesture and provide the corresponding display. The spatial position of the virtual object can include the depth of field of the virtual object in the current application scenario picture.

In 430, in response to a received first gesture operation, the system changes the manner in which the virtual object is displayed.

In operation 430, in responding to the first gesture operation, the system can change one or more of the ways (manners) in which the virtual object is displayed:

Furthermore, one or more virtual objects associated with the first gesture can exist. If more than one virtual object associated with the first gesture exists, then different positions on the user's hand can be associated with corresponding virtual objects. Accordingly, in operation 430, the manners in which the corresponding virtual objects are displayed can change in response to statuses of positions on the user's hand in a received first gesture operation. The different positions on the user's hand can include: different fingers of the user's hand and different finger joints of the user's hand.

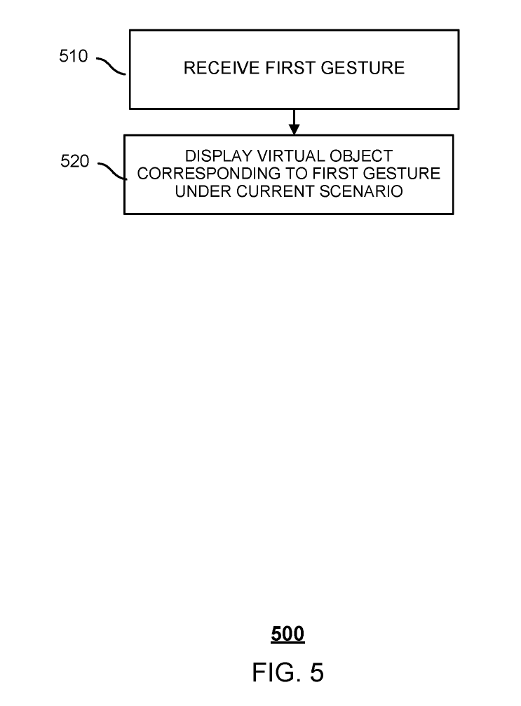

FIG. 5 is a flowchart of another embodiment of a process for gesture-based interactions. In some embodiments, the process 500 is implemented by the system 100 of FIG. 1 and comprises:

In 510, the system receives a first gesture. For example, the first gesture can relate to a palm shaking.

In operation 510, the received gesture can be captured by a gesture-capturing component. The gesture-capturing component can include: an infrared camera, various sensors (such as, for example, an optical sensor, an accelerometer, etc.) or a combination thereof.

Furthermore, prior to operation 510, the system can perform gesture recognition.

In addition, the system can acquire a mapping relationship between a gesture and a virtual object under the application scenario after the first gesture is received, and then determine the virtual object associated with the first gesture under the first application scenario based on the mapping relationship. The mapping relationship can be predefined or set by a server.

In 520, the system displays the virtual object corresponding to the first gesture under the current scenario. In some embodiments, the display status of the virtual object is associated with the first gesture. In one example, if the first gesture relates to the palm facing upward, the virtual object associated with the first gesture is a knife. In another example, if the first gesture relates to a paw (e.g., palm of a hand is facing downward with all the fingers extended), the virtual object associated with the virtual object is a puppet.

In operation 520, when the virtual object is being displayed, the system can display the virtual object based on the current status of the first gesture. For example, the system can perform one or more of the following operations:

The system can determine display attributes of the virtual object based on the current status of the first gesture and provide the corresponding display. For example, the status of the palm (e.g., up and down) can control a color being displayed. The display attributes of the virtual object can include color, transparency, gradient effect, or any combination thereof.

The system can determine a form of the virtual object based on the current status of the first gesture and provide the corresponding display. In this respect, the form of the virtual object can include virtual object length, width, and height, virtual object shape, or any combination thereof.

The system can determine an attitude of the virtual object based on the current status of the first gesture and provide the corresponding display. The attitude of the palm can control the attitude of the virtual object. The attitude of the virtual object can include elevation angle, angle of rotation, angle of deflection, or any combination thereof.

The system can determine a spatial position of the virtual object based on the current status of the first gesture and provide the corresponding display. As an example, the spatial position of the virtual object can be determined based on a position of the face in relation to the palm performing the first gesture. The spatial position of the virtual object can include a depth of field of the virtual object in the current application scenario picture.

The correspondence between the different statuses of the first gesture and the ways in which the virtual object is displayed can be predefined or set by a server.

Furthermore, one or more virtual objects associated with the first gesture can exist. If more than one virtual object associated with the first gesture exists, then different positions on the user's hand can be associated with corresponding virtual objects. The different positions on the user's hand include different fingers of the user's hand, different finger joints of the user's hand, or a combination thereof.

From the description above, the system can, based on the first application scenario, determine a virtual object associated with a gesture under the first application scenario; perform a response based on a first gesture operation under the first application scenario; subject the virtual object to a corresponding operation; and adaptively determine, under multiple application scenarios, the virtual object associated with the gesture with the result that the gesture matches the virtual object in the corresponding scenario.

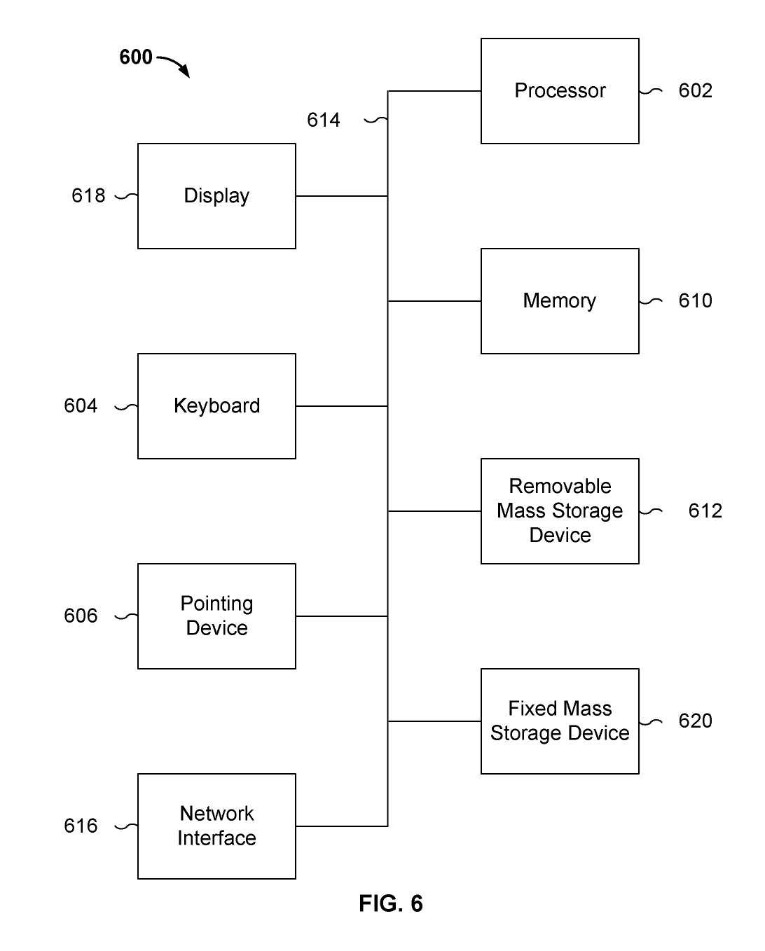

FIG. 6 is a functional diagram illustrating a programmed computer system for gesture-based interactions. As will be apparent, other computer system architectures and configurations can be used to perform gesture-based interactions. Computer system 600, which includes various subsystems as described below, includes at least one microprocessor subsystem (also referred to as a processor or a central processing unit (CPU)) 602. For example, processor 602 can be implemented by a single-chip processor or by multiple processors. In some embodiments, processor 602 is a general purpose digital processor that controls the operation of the computer system 600. Using instructions retrieved from memory 610, the processor 602 controls the reception and manipulation of input data, and the output and display of data on output devices (e.g., display 618).

Processor 602 is coupled bi-directionally with memory 610, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 602. Also as is well known in the art, primary storage typically includes basic operating instructions, program code, data and objects used by the processor 602 to perform its functions (e.g., programmed instructions). For example, memory 610 can include any suitable computer-readable storage media, described below, depending on whether, for example, data access needs to be bi-directional or uni-directional. For example, processor 602 can also directly and very rapidly retrieve and store frequently needed data in a cache memory (not shown).

A removable mass storage device 612 provides additional data storage capacity for the computer system 600, and is coupled either bi-directionally (read/write) or uni-directionally (read only) to processor 602. For example, storage 612 can also include computer-readable media such as magnetic tape, flash memory, PC-CARDS, portable mass storage devices, holographic storage devices, and other storage devices. A fixed mass storage 620 can also, for example, provide additional data storage capacity. The most common example of mass storage 620 is a hard disk drive. Mass storages 612 and 620 generally store additional programming instructions, data, and the like that typically are not in active use by the processor 602. It will be appreciated that the information retained within mass storages 612 and 620 can be incorporated, if needed, in standard fashion as part of memory 610 (e.g., RAM) as virtual memory.

In addition to providing processor 602 access to storage subsystems, bus 614 can also be used to provide access to other subsystems and devices. As shown, these can include a display monitor 618, a network interface 616, a keyboard 604, and a pointing device 606, as well as an auxiliary input/output device interface, a sound card, speakers, and other subsystems as needed. For example, the pointing device 606 can be a mouse, stylus, track ball, or tablet, and is useful for interacting with a graphical user interface.

The network interface 616 allows processor 602 to be coupled to another computer, computer network, or telecommunications network using a network connection as shown. For example, through the network interface 616, the processor 602 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 602 can be used to connect the computer system 600 to an external network and transfer data according to standard protocols. For example, various process embodiments disclosed herein can be executed on processor 602, or can be performed across a network such as the Internet, intranet networks, or local area networks, in conjunction with a remote processor that shares a portion of the processing. Additional mass storage devices (not shown) can also be connected to processor 602 through network interface 616.

An auxiliary I/O device interface (not shown) can be used in conjunction with computer system 600. The auxiliary I/O device interface can include general and customized interfaces that allow the processor 602 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 6 is but an example of a computer system suitable for use with the various embodiments disclosed herein. Other computer systems suitable for such use can include additional or fewer subsystems. In addition, bus 614 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
determining, based on an application scenario, a virtual object associated with a gesture under the application scenario, the gesture being performed by a user and detected by a virtual reality (VR) system;
outputting the virtual object to be displayed; and
in response to the gesture, subjecting the virtual object to an operation associated with the gesture.

2. The method as described in claim 1, wherein the determining of the virtual object associated with the gesture under the application scenario comprises:
acquiring a mapping relationship between the gesture and the virtual object under the application scenario; and
determining, based on the mapping relationship, the virtual object associated with the gesture under the application scenario.

3. The method as described in claim 1, wherein:
the determining of the virtual object associated with the gesture under the application scenario comprises:
acquiring a mapping relationship between a gesture and the virtual object under the application scenario; and
determining, based on the mapping relationship, the virtual object associated with the gesture under the application scenario; and
the mapping relationship is predefined or is set by a server.

4. The method as described in claim 1, further comprising:
performing a gesture recognition technique to obtain the gesture.

5. The method as described in claim 1, further comprising:
performing gesture recognition, comprising:
recognizing statuses of a user's finger joints, wherein different finger joints correspond to different positions on the virtual object; and
wherein the subjecting of the virtual object to the operation associated with the gesture comprises:
in response to the statuses of the user's finger joints in the gesture subjecting the different positions of the virtual object to the operation associated with the gesture.

6. The method as described in claim 1, wherein the displaying of the virtual object comprises one or more of:
determining display attributes of the virtual object based on the gesture and providing a corresponding display;
determining a form of the virtual object based on the gesture and providing a corresponding display;
determining an attitude of the virtual object based on the gesture and providing a corresponding display; and/or
determining a spatial position of the virtual object based on the gesture and providing a corresponding display.

7. The method as described in claim 1, wherein the virtual object associated with the gesture includes two or more virtual objects.

8. The method as described in claim 1, wherein:
in response to a determination that more than one virtual object associated with the gesture exists, different positions on a user's hand relate to various virtual objects; and
in response to the gesture, subjecting the more than one virtual object to the operation associated with the gesture, comprising:
in response to a statuses of a position on the user's hand in the gesture, subjecting the more than one virtual object to the operation associated with the gesture.

9. The method as described in claim 1, wherein:
in response to a determination that more than one virtual object associated with the gesture exists, different positions on a user's hand relate to corresponding virtual objects; and
in response to the gesture, subjecting the more than one virtual object to the operation associated with the gesture, comprising:
in response to statuses of positions on the user's hand in the gesture, subjecting the more than one virtual object to the operation associated with the gesture; and
the different positions on the user's hand comprise:
different fingers of the user's hand;
different finger joints of the user's hand; or
a combination thereof.

10. The method as described in claim 1, wherein in response to the gesture, subjecting the virtual object to the operation associated with the gesture comprises:
performing an operation on the virtual object based on motion information in the gesture, the motion information in the gesture including motion track, motion speed, motion magnitude, rotation angle, hand status, or any combination thereof.

11. The method as described in claim 1, wherein the application scenario comprises: a virtual reality (VR) application scenario, an augmented reality (AR) application scenario, a mixed reality (MR) application scenario, or any combination thereof.

12. The method as described in claim 1, wherein a current application includes the application scenario.

13. A method, comprising:
determining, based on an application scenario, a virtual object associated with a gesture under the application scenario, the gesture being performed by a user and detected by a virtual reality (VR) system;
outputting the virtual object to be displayed; and
in response to the gesture, changing a manner in which the virtual object is displayed.

14. The method as described in claim 13, wherein the determining of the virtual object associated with a gesture under the application scenario comprises:
acquiring a mapping relationship between the gesture and the virtual object under the application scenario; and
determining the virtual object associated with the gesture under the application scenario based on the mapping relationship.

15. The method as described in claim 13, wherein:
the determining of the virtual object associated with a gesture under the application scenario comprises:
acquiring a mapping relationship between a gesture and the virtual object under the application scenario; and
determining the virtual object associated with the gesture under the application scenario based on the mapping relationship; and
the mapping relationship is predefined or is set by a server.

16. The method as described in claim 13, further comprising:
before the determining of the virtual object associated with the gesture under the application scenario, performing a gesture recognition technique to obtain the gesture, comprising:
recognizing statuses of the user's finger joints, wherein the different finger joints correspond to different positions on the virtual object; and
in response to the gesture, subjecting the virtual object to the operation associated with the gesture, comprising:
in response to the statuses of the user's finger joints in the gesture, subjecting the corresponding positions of the virtual object to the operation associated with the gesture.

17. The method as described in claim 13, wherein the displaying of the virtual object comprises one or more of:
determining the display attributes of the virtual object based on the gesture and providing the corresponding display;
determining a form of the virtual object based on the gesture and providing the corresponding display;
determining an attitude of the virtual object based on the gesture and providing the corresponding display; and/or
determining a spatial position of the virtual object based on the gesture and providing the corresponding display.

18. The method as described in claim 13, wherein the virtual object associated with the gesture includes two or more virtual objects.

19. The method as described in claim 18, wherein:
in response to a determination that more than one virtual object associated with the gesture exists, different positions on the user's hand relate to various virtual objects; and
in response to the gesture, changing a manner in which the virtual object is displayed, comprising:
in response to a status of a position on the user's hand in the gesture, changing the manner in which the corresponding virtual objects are displayed.

20. The method as described in claim 19, wherein the different positions on the user's hand include different fingers of the user's hand, different finger joints of the user's hand, or any combination thereof.

21. The method as described in claim 13, wherein the changing of the manner in which the virtual object is displayed comprises:
changing display attributes of the virtual object;
changing form of the virtual object;
changing an attitude of the virtual object;
changing a spatial position of the virtual object; or
any combination thereof.

22. The method as described in claim 13, wherein the application scenario comprises:
a virtual reality (VR) application scenario; or
an augmented reality (AR) application scenario; or
a mixed reality (MR) application scenario.

23. The method as described in claim 13, wherein a current application includes one or more application scenarios.

24. A method, comprising:
receiving a gesture, the gesture being performed by a user and detected by a virtual reality (VR) system; and
outputting a virtual object to be displayed, the virtual object being associated with the gesture under a current application scenario, wherein a display status of the virtual object is associated with the gesture, and wherein the virtual object is selected based on the gesture.

25. The method as described in claim 24, further comprising:
after the receiving of the gesture:
acquiring a mapping relationship between the gesture and the virtual object under the application scenario; and
determining, based on the mapping relationship, the virtual object associated with the gesture under the application scenario.

26. The method as described in claim 24, further comprising:
after the receiving of the gesture:
acquiring a mapping relationship between a gesture and the virtual object under the application scenario; and
determining, based on the mapping relationship, the virtual object associated with the gesture under the application scenario, wherein the mapping relationship is predefined or is set by a server.

27. The method as described in claim 24, wherein the displaying of the virtual object associated with the gesture under the current application scenario comprises one or more of:
determining display attributes of the virtual object based on the gesture, and providing a corresponding display;
determining a form of the virtual object based on the gesture, and providing a corresponding display;
determining an attitude of the virtual object based on the gesture, and providing a corresponding display; and/or
determining a spatial position of the virtual object based on the gesture, and providing a corresponding display.

28. The method as described in claim 24, wherein the virtual object associated with the gesture includes two or more virtual objects.

29. The method as described in claim 24, wherein:
in response to a determination that more than one virtual object associated with the gesture exist, different positions on a user's hand relate to corresponding virtual objects.

30. The method as described in claim 24, wherein the current application scenario comprises:
a virtual reality (VR) application scenario;
an augmented reality (AR) application scenario; or
a mixed reality (MR) application scenario.

31. The method as described in claim 24, wherein a current application includes one or more application scenarios.

32. A computer program product being embodied in a non-transitory computer readable medium and comprising computer instructions for:
determining, based on an application scenario, a virtual object associated with a gesture under the application scenario, the gesture being performed by a user and detected by a virtual reality (VR) system;
outputting the virtual object to be displayed; and
in response to the gesture, subjecting the virtual object to an operation associated with the gesture.

33. A computer program product being embodied in a non-transitory computer readable medium and comprising computer instructions for:
determining, based on an application scenario, a virtual object associated with a gesture under the application scenario, the gesture being performed by a user and detected by a virtual reality (VR) system;
outputting the virtual object to be displayed; and
in response to the gesture, changing a manner in which the virtual object is displayed.

34. A computer program product being embodied in a non-transitory computer readable medium and comprising computer instructions for:
receiving a gesture, the gesture being performed by a user and detected by a virtual reality (VR) system; and
outputting a virtual object to be displayed, the virtual object being associated with the gesture under a current application scenario, wherein a display status of the virtual object is associated with the gesture, and wherein the virtual object is selected based on the gesture.

35. A system, comprising:
a processor; and
a memory coupled with the processor, wherein the memory is configured to provide the processor with instructions which when executed cause the processor to:
determine, based on an application scenario, a virtual object associated with a gesture under the application scenario, the gesture being performed by a user and detected by a virtual reality (VR) system;
output the virtual object to be displayed; and
in response to the gesture, subject the virtual object to an operation associated with the gesture.

36. A system, comprising:
a display;
a processor; and
a memory coupled with the processor, wherein the memory is configured to provide the processor with instructions which when executed cause the processor to:
determine, based on an application scenario, a virtual object associated with a gesture under the application scenario, the gesture being performed by a user and detected by a virtual reality (VR) system;
output the virtual object to be displayed; and
in response to the gesture, subject the virtual object to an operation associated with the gesture.

37. A system, comprising:
a display;
a processor; and
a memory coupled with the processor, wherein the memory is configured to provide the processor with instructions which when executed cause the processor to:
determine, based on an application scenario, a virtual object associated with a gesture under the application scenario, the gesture being performed by a user and detected by a virtual reality (VR) system;
output the virtual object to be displayed; and
in response to the gesture, change a manner in which the virtual object is displayed.

38. A system, comprising:
a display;
a processor; and
a memory coupled with the processor, wherein the memory is configured to provide the processor with instructions which when executed cause the processor to:
receive a gesture, the gesture being performed by a user and detected by a virtual reality (VR) system; and
output the virtual object to be displayed, the virtual object being associated with the gesture under a current application scenario, wherein a display status of the virtual object is associated with the gesture, and wherein the virtual object is selected based on the gesture.
